(19) United States
(12) Patent Application Publication
(10) Pub. No.: US 2022/0343699 A1
(43) Pub. Date: Oct. 27, 2022

(54) METHOD AND DEVICE FOR PROCESSING DATA ASSOCIATED WITH AN ELECTRONIC UNIT FOR A VEHICLE

(71) Applicant: Robert Bosch GmbH, Stuttgart (DE)

(72) Inventors: Florian Schmid, Korntal (DE); Frank Lustig, Stuttgart (DE); Jens Schneider, Stuttgart (DE); Uwe Kreikenbohm, Korb (DE); Wolfgang Stoer, Asperg (DE)

(21) Appl. No.: 17/719,676

(22) Filed: Apr. 13, 2022

(30) Foreign Application Priority Data
Apr. 21, 2021 (DE) 10 2021 203 940.5

(51) Int. Cl. G07C 5/00; G07C 5/08

(52) U.S. Cl. CPC G07C 5/008; G07C 5/085; G07C 5/0816

(57) ABSTRACT

A computer-implemented method for processing data associated with an electronic unit for a vehicle, for example, a motor vehicle. The method includes: providing a first application, for example, a measuring application executable on a computing device, which is designed to carry out and/or support a communication, for example, with respect to the data, between at least one further application executable on the computing device and at least one further unit, for example, provided externally of the unit.

### FIELD

The present invention relates to a method for processing data associated with an electronic unit for a vehicle, for example, a motor vehicle.

The present invention further relates to a device for processing data associated with an electronic unit for a vehicle, for example, a motor vehicle.

### SUMMARY

Exemplary specific example embodiments of the present invention relate to a method, for example, to a computer-implemented method, for processing data associated with an electronic unit for a vehicle, for example, a motor vehicle, including: providing a first application executable on a computing device, for example, a measuring application, which is designed to execute and/or to support a communication, for example, with respect to the data, between at least one further application executable on the computing device and at least one further unit, for example, provided externally of the unit.

In further exemplary specific embodiments of the present invention, the unit may, for example, be an embedded system and/or a control unit and/or a vehicle computer.

In further exemplary specific embodiments of the present invention, the at least one further unit provided, for example, externally of the unit, may, for example, be a measuring system and/or a calibration system, and/or, for example, an automatic data logger, and/or a forwarding of the data, for example, into a cloud, and/or a test bench system, and/or a HiL (Hardware-in-the-Loop) system, and/or a system for shadow testing.

In further exemplary specific embodiments of the present invention, it may be provided that the unit is a control unit, for example, an ECU (electronic control unit), and that the at least one further unit is a computer, for example, a personal computer.

In further exemplary specific embodiments of the present invention, at least one of the following cause-effect chains 1. through 5. cited by way of example below is implementable.

1. ECU (for example, control unit)=>external unit (for example, PC), i.e., for example, forwarding of data from the unit, for example, ECU, to the at least one further unit, for example, PC, for example, for measuring data, for example, including at least one of the following aspects: extracting data and/or forwarding data and/or storing data and/or manipulating data and/or visualizing data and/or deleting data,

2. ECU (for example, control unit)=>external unit (for example, PC) for loading parameters, for example, including at least one of the following aspects: extracting parameters and/or forwarding parameters and/or storing parameters and/or manipulating parameters and/or visualizing parameters, 3. ECU (for example, control unit)=>other ECU or other ECU partition or other software, for example, control unit=>software in another runtime environment and/or in another control unit, for example, ASW or measuring application (for example, “postSOP”), for example, a telemetry application/data recording for vehicle fleets and/or a software in passive test operation, for example, including at least one of the following aspects: extracting data and/or forwarding data and/or storing data and/or manipulating data=>optionally control response back to ECU=>optionally data forwarding to an external system (for example, via mobile communications and/or cloud),

4. external unit (for example, PC)=>ECU (for example, control unit), for example, for manipulating parameters, for example, including at least one of the following aspects: loading parameters and/or forwarding parameters and/or holding parameters and/or activating parameters,

5. external unit (for example, PC),=>ECU (for example, control unit), for example, for playing back data, for example, including at least one of the following aspects: loading data and/or forwarding data and/or manipulating data.

In further exemplary specific embodiments of the present invention, it is provided that the method further includes: bundling, with the aid of the first application, for example, the measuring application, the communication between the at least one further application executable on the computing device and the at least one further unit. In further exemplary specific embodiments, at least one of the following functions alternatively or in addition to the bundling may also be executed: filtering, selecting, processing or pre-processing, execution of cryptographic functions or primitives, for example, encrypting and/or signing, at least temporarily storing or buffering.

In further exemplary specific embodiments of the present invention, it is provided that the communication relates to functionalities with respect to at least one of the following elements: a) measuring, b) calibrating, c) monitoring, d) diagnosis, e) configuring, f) parameterizing, g) verifying, h) validating.

In further exemplary specific embodiments of the present invention, it is provided that the first application, for example, the measuring application, includes a publish and/or subscribe mechanism for a service-oriented communication.

In further exemplary specific embodiments of the present invention, non-“Publish & Subscribe” protocols, i.e., for example, protocols which do not use any publish and/or subscribe mechanism, for example, XCPoE (Universal Measurement and Calibration Protocol over Ethernet) may also be used.

In further exemplary specific embodiments of the present invention, it is provided that the method includes: using the publish and/or subscribe mechanism, for example, for providing for example, as needed, between applications, for example, the further applications, replaceable or replaced pieces of information or data, for example, for a, for example, external, recording and/or visualization and/or for at least one of the following elements: filtering, selecting, processing or pre-processing, execution of cryptographic functions or primitives, for example, encrypting and/or signing, at least temporarily storing or buffering, playing back.

In further exemplary specific embodiments of the present invention, it is provided that the method includes: providing a library, which is designed to provide at least one interface for the at least one further application, for example, for an access to data, for example, internal data, of the at least one further application, for example, internal data of the at least one further application for, for example, a measuring and/or calibrating and/or monitoring and/or diagnosis and/or configuring and/or parameterizing.

In further exemplary specific embodiments of the present invention, it is provided that the method includes: making accessible, for example, with the aid of the first application, for example, the measuring application, for example, using the interface, the internal data of the at least one further application, for example, for measuring functionalities and/or calibration functionalities and/or for functionalities relating to monitoring and/or diagnosis and/or configuring and/or parameterizing, for example, for the at least one further unit.

In further exemplary specific embodiments of the present invention, it is provided that the method includes: collecting and/or writing or reading or manipulating, for example, with the aid of the first application, for example, the measuring application, data, for example, of a runtime environment, the runtime environment being, for example, an AUTOSAR Adaptive Instance and/or an operating system, for example, a Unix-like operating system, for example, a POSIX operating system, and/or another operating system, for example, a real-time operating system (RTOS), in order, for example, optionally, to enable a state monitoring of a software system. Alternatively or in addition, a monitoring of resources and/or of a performance and/or an influencing of states may be carried out in further exemplary specific embodiments.

In further exemplary specific embodiments of the present invention, it is provided that the method includes: using a method for tunneling, for example, logical network connections, for example, in order, optionally, to forward data to the at least one further unit.

In further exemplary specific embodiments of the present invention, it is provided that the method includes at least one of the following elements: a) activating, for example, at least temporarily activating, the first application, for example, the measuring application, b) deactivating, for example, at least temporarily deactivating, the first application, for example, the measuring application, the library being left incorporated or remaining incorporated in the at least one further application, for example, during the activating and/or during the deactivating.

In further exemplary specific embodiments of the present invention, cryptographic methods or functions may be used, for example, for configuring and/or activating and/or logging onto the first application.

Further exemplary specific embodiments of the present invention relate to a device for carrying out the method according to the specific embodiments.

Further exemplary specific embodiments of the present invention relate to a computer-readable memory medium, including commands which, upon execution by a computer, prompt the computer to carry out the method according to the specific embodiments.

Further exemplary specific embodiments of the present invention relate to a computer program, including commands which, upon execution of the program by a computer, prompt the computer to carry out the method according to the specific embodiments.

Further exemplary specific embodiments of the present invention relate to a data medium signal, which transfers and/or characterizes the computer program according to the specific embodiments.

Further exemplary specific embodiments of the present invention relate to a use of the method according to the specific embodiments and/or of the device according to the specific embodiments and/or of the computer-readable memory medium according to the specific embodiments and/or of the computer program according to the specific embodiments and/or of the data medium signal according to the specific embodiments for at least one of the following elements: a) measuring and/or storing and/or visualizing data, for example, data processable or processed in a unit for a vehicle, for example, a control unit or a vehicle computer, for example, in an ongoing operation or in real time (and/or faster or slower than real time), for example, at a rate at which the data occur or accrue or are detectable, b) developing units for a vehicle, for example, control units or vehicle computers, c) initial parameterizing and/or modifying during runtime, for example, calibrating, functionalities and/or algorithms, d) supplementing individual applications by a functionality for measuring and/or changing, for example, calibrating, data, for example, internal data, e) creating or maintaining or ensuring a compatibility of measuring accesses and/or calibration accesses for the device, for example, control unit or vehicle computer, for example, also in the case of distributed development of applications, f) limiting an access to a measuring functionality and/or calibration functionality, for example, with respect to application-internal data of the at least one further application to applications within a, for example, identical runtime environment, for example, a protection of an integrity of the runtime environment, for example, from an installation and/or execution of unauthorized applications, a protection for the measuring functionality and calibration functionality being ensured.

Further features, possible applications and advantages of the present invention result from the following description of exemplary embodiments of the present invention, which are represented in the figures. All features described or represented in this case, alone or in arbitrary combination, form the subject matter of the present invention, regardless of their wording or representation in the description or in the figures.

### BRIEF DESCRIPTION OF THE DRAWINGS

FIG. 1 schematically shows a simplified flowchart according to exemplary specific embodiments of the present invention.

FIG. 2 schematically shows a simplified block diagram according to further exemplary specific embodiments of the present invention.

FIG. 3 schematically shows a simplified flowchart according to further exemplary specific embodiments of the present invention.

FIG. 4 schematically shows a simplified flowchart according to further exemplary specific embodiments of the present invention.

FIG. 5 schematically shows a simplified flowchart according to further exemplary specific embodiments of the present invention.

FIG. 6 schematically shows a simplified flowchart according to further exemplary specific embodiments of the present invention.

FIG. 7 schematically shows a simplified flowchart according to further exemplary specific embodiments of the present invention.

FIG. 8 schematically shows a simplified block diagram according to further exemplary specific embodiments of the present invention.

FIG. 9 schematically shows a simplified block diagram according to further exemplary specific embodiments of the present invention.

FIG. 10 schematically shows a simplified block diagram according to further exemplary specific embodiments of the present invention.

FIG. 11 schematically shows a simplified block diagram according to further exemplary specific embodiments of the present invention.

FIG. 12 schematically shows a simplified block diagram according to further exemplary specific embodiments of the present invention.

FIG. 13 schematically shows aspects of uses according to further exemplary specific embodiments of the present invention.

### DETAILED DESCRIPTION OF EXAMPLE EMBODIMENTS

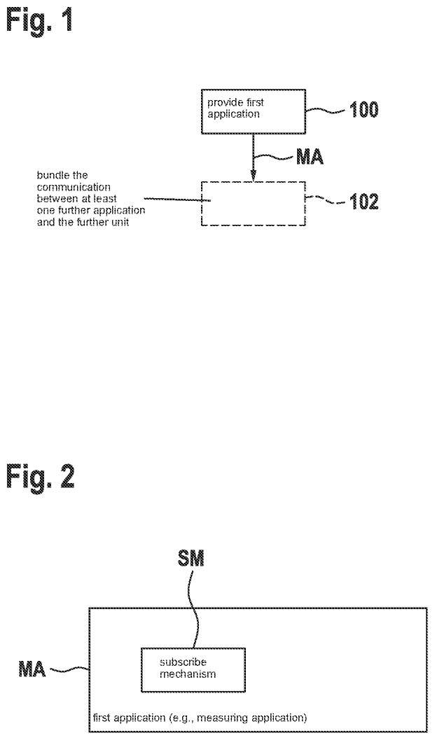

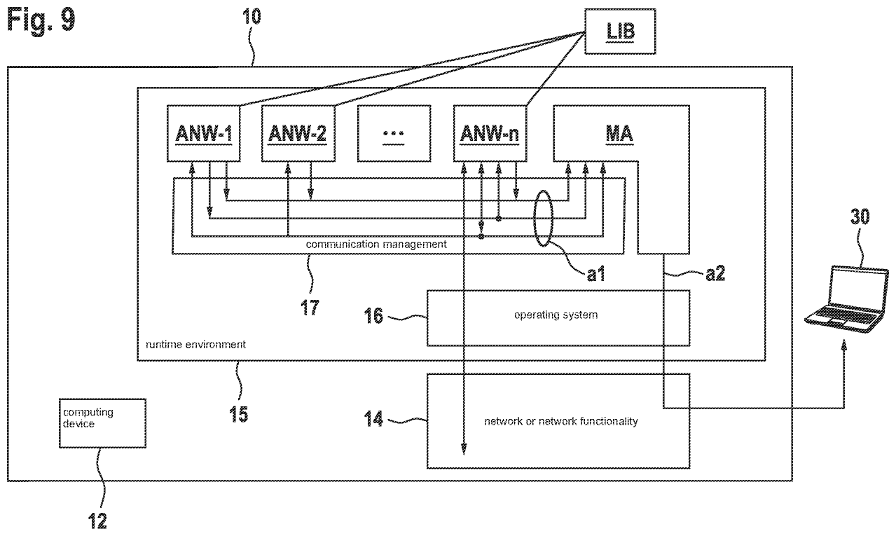

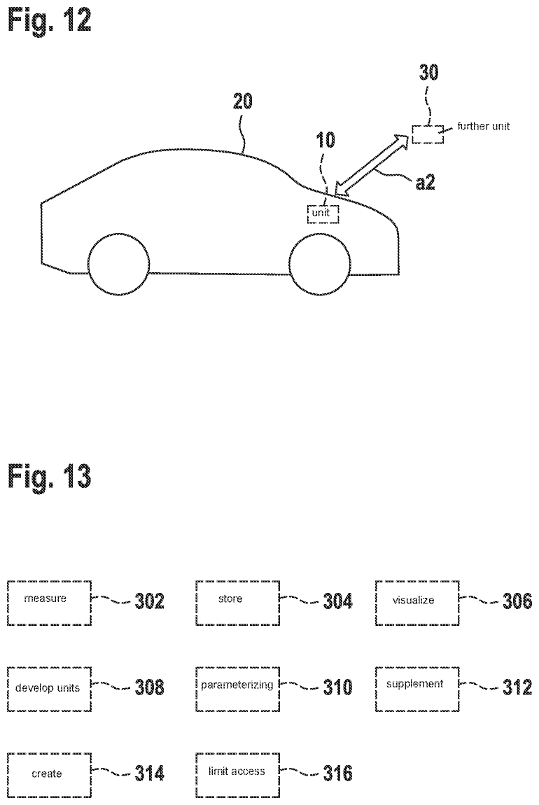

Exemplary specific embodiments, cf. FIGS. 1, 9 and 12, relate to a method, for example, to a computer-implemented method, for processing data associated with an electronic unit 10 (FIGS. 9, 12) for a vehicle 20, for example, a motor vehicle 20, including: providing 100 (FIG. 1) a first application, for example, measuring application MA, executable on a computing device 12 (FIG. 9), which is designed to execute and/or to support a communication a1, a2 (FIG. 9), for example, with respect to the data, between at least one further application ANW-1, ANW-2, . . . , ANW-n executable on computing device 12 and at least one further unit 30, for example, provided externally of device 10.

In further exemplary specific embodiments, unit 10 (FIG. 9) may, for example, be an embedded system, and/or a control unit and/or a vehicle computer.

In further exemplary specific embodiments, it may be provided that unit 10 is a control unit, for example, an ECU (electronic control unit), and that the at least one further unit 30 is a computer, for example, a personal computer.

In further exemplary specific embodiments, at least one of the following cause-effect chains 1. through 5. cited by way of example below is implementable:

1. ECU10=>PC 30, i.e., for example, forwarding data from the unit, for example, ECU 10 to the at least one further unit 30, for example, PC, for example, for measuring data, for example, including at least one of the following aspects: extracting data=>forwarding data=>storing data=>manipulating data=>visualizing data,

2. ECU 10=>PC 30, for example, for loading parameters, for example, including at least one of the following aspects: extracting parameters=>forwarding parameters=>storing parameters=>manipulating parameters=>visualizing parameters,

3. ECU 10=>ECU (not shown) or other ECU partition or other software, for example, ASW or measuring application (for example, “postSOP”), for example, including at least one of the following aspects: extracting data=>forwarding data=>storing data=>manipulating data=>optionally control response back to ECU=>optionally data forwarding to external system (for example, via mobile communications and/or the cloud),

4. PC 30=>ECU 10, for example, for manipulating parameters, for example, including at least one of the following aspects: loading parameters=>forwarding parameters=>holding parameters=>activating parameters,

5. PC 30=>ECU 10, for example, for playing back data, for example, including at least one of the following aspects: loading data=>forwarding data.

In further exemplary specific embodiments, computing device 12 may include one or multiple processing cores (not shown in FIG. 9) for the specific embodiment of computer programs, for example, for carrying out the method according to the specific embodiments and/or at least one of the further applications ANW-1, . . . , ANW-n.

In further exemplary specific embodiments, mechanisms or configurations may also be used for virtualizing (for example, hypervisor) and/or for other partitioning.

Element 14 symbolizes by way of example a network or a network functionality, which may be assigned to unit 10 in further exemplary specific embodiments, for example, for the exchange of data with unit 30.

Element 15 symbolizes by way of example a runtime environment according to further exemplary embodiments.

Element 16 symbolizes by way of example an operating system according to further exemplary specific embodiments.

Element 17 symbolizes by way of example a communication management according to further exemplary specific embodiments. For example, communication management 17 may be provided by runtime environment 15 and/or by operating system 16.

In further exemplary specific embodiments, the at least one further unit 30, for example, provided externally of the unit, may, for example, be a measuring system and/or calibration system.

In further exemplary specific embodiments, it is provided that the method further includes: bundling 102 (FIG. 1), with the aid of the first application, for example, measuring application MA, the communication a1, a2 between the at least one further application ANW-1, ANW-2, . . . , ANW-n executable on the computing device 10 and the at least one further unit 30, for example, multiple first data streams a1 to form a second data stream a2. In further exemplary specific embodiments, bundling 102 may also be applied to data from runtime environment 15 or from operating system 16.

In further exemplary specific embodiments, it is provided that communication a1, a2 relates to functionalities with respect to at least one of the following elements: a) measuring, b) calibrating, and/or c) monitoring, and/or d) diagnosis, and/or e) configuring, and/or f) parameterizing, and/or g) verifying, and/or h) validating.

In further exemplary specific embodiments, FIG. 2, it is provided that the first application, for example, measuring application MA, includes a publish and/or subscribe mechanism SM for a service-oriented communication. In this way, the first application, for example, measuring application MA is able, for example, to also bundle or forward to unit 30 service-oriented communication or data communication of further applications ANW-1, etc.

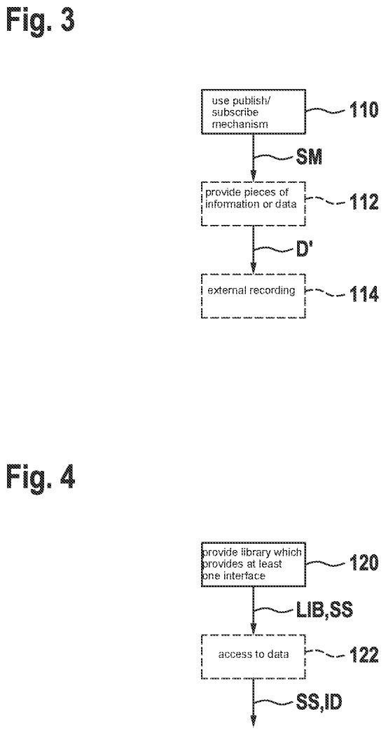

In further exemplary specific embodiments, FIG. 3, it is provided that the method includes: using 110 publish and/or subscribe mechanism SM, for example, for a, for example, if needed, provision 112 of pieces of information or data D′ exchangeable or exchanged between applications, for example, further applications ANW-1, etc., for a, for example, external recording 114 and/or visualization and/or for at least one of the following elements: filtering, selecting, processing or pre-processing, execution of cryptographic functions or primitives, for example, encrypting and/or signing, at least temporarily storing or buffering, playing back.

In further exemplary specific embodiments, FIG. 4, it is provided that the method includes: providing 120 a library LIB (see also FIG. 9), which is designed to provide at least one interface SS for the at least one further application ANW-1, etc., for example, for an access (122) to internal data ID of the at least one further application ANW-1, etc., for example, internal data ID of the at least one application for a measuring and/or calibrating.

In further exemplary specific embodiments, for example, one or multiple of further applications ANW-1, . . . , ANW-n according to FIG. 9 may utilize functions of the first application, for example, measuring application MA, with the aid of library LIB.

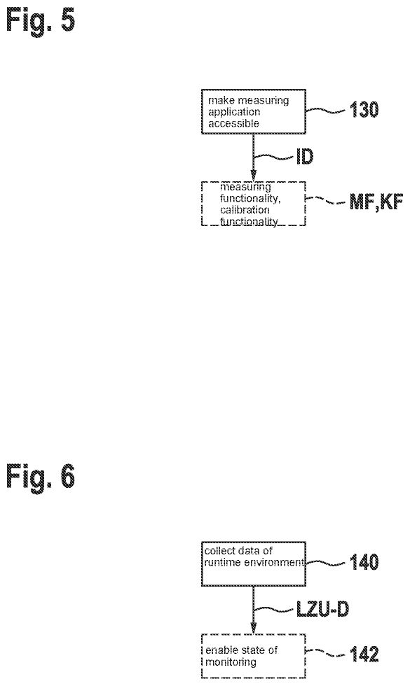

In further exemplary specific embodiments, FIG. 5, it is provided that the method includes: making accessible 130, for example, with the aid of the first application, for example, measuring application MA (FIG. 9), for example, using interface SS, internal data ID of the at least one further application ANW-1, etc., for example, for measuring functionalities MF and/or calibration functionalities KF, for example, for the at least one further unit 30 (FIG. 12).

In further exemplary specific embodiments, FIG. 6, it is provided that the method includes: collecting 140 and/or writing or reading or manipulating, for example, with the aid of the first application, for example, measuring application MA (FIG. 9), data LZU-D of a runtime environment 15, 16 (FIG. 9), runtime environment 15, 16 being, for example, an AUTOSAR Adaptive Instance 15 and/or an operating system 16, for example, a Unix-like operating system, for example, a POSIX operating system, for example, in order, optionally, to enable a state monitoring 142 of a software system.

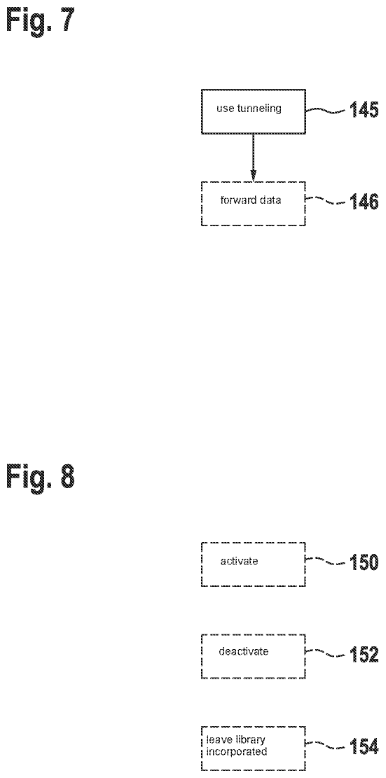

In further exemplary specific embodiments, FIG. 7, it is provided that the method includes: using 145 a method for tunneling, for example, logical network connections, for example, in order, optionally, to forward data to the at least one further unit 30, cf. optional block 146 according to FIG. 7.

In further exemplary specific embodiments, FIG. 8, it is provided that the method includes at least one of the following elements: a) activating 150, for example, at least temporarily activating, the first application, for example, measuring application MA (FIG. 9), b) deactivating 152 (FIG. 8), for example, at least temporarily deactivating, the first application, for example, measuring application MA, library LIB being left incorporated, cf. optional block 154, or remaining incorporated in the at least one further application ANW-1, . . . , ANW-n, for example, during the activating 150 and/or during the deactivating 152.

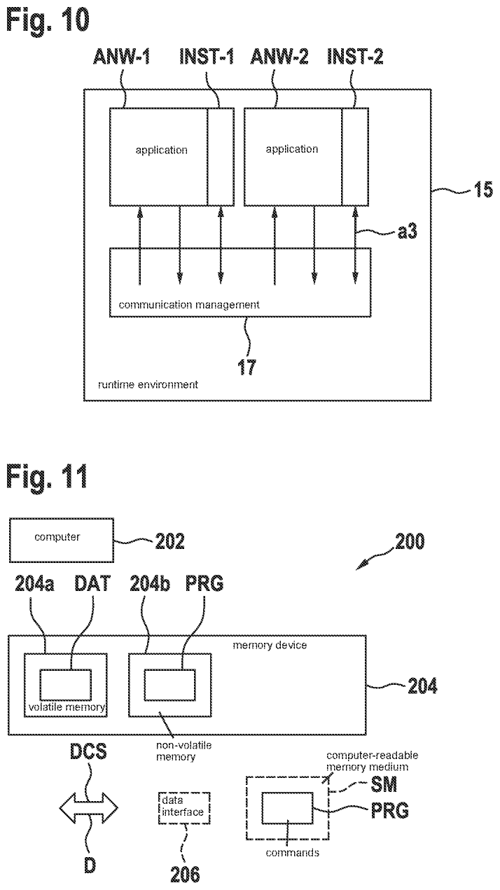

FIG. 10 schematically shows a simplified block diagram according to further exemplary specific embodiments. For example, each of the two further applications ANW-1, ANW-2 is assigned a respective INST-1, INST-2 of library LIB (FIG. 9), which implements, for example, at least one service, a3, for example, a communication service, for example, a measuring and/or calibration service. For the sake of clarity, reference numeral a3 is assigned in FIG. 10 only to instance INST-2, the same applies, however, also to instance INST-1, see the unmarked double arrow between blocks INST-1, 17 according to FIG. 10.

Further exemplary specific embodiments, FIG. 11, relate to a device 200 for carrying out the method according to the specific embodiments. For example, unit 10 according to FIGS. 9, 12, may have a configuration at least similar to device 200 according to FIG. 11.

In further exemplary specific embodiments, it is provided that device 200 (FIG. 11) includes: a computing device (“computer”) 202 including at least one processing core, a memory device 204 assigned to computing device 202 for the at least temporary storing of at least one of the following elements: a) data DAT (for example, data D associated with electronic unit 10, for example, data, which are associated with measuring functionality MF (FIG. 5) and/or with calibration functionality KF), b) computer program PRG, for example, for carrying out the method according to the specific embodiments (and/or for example, at least one of further applications ANW-1, ANW-n, or operating system 16).

In further specific exemplary embodiments, memory device 204 includes a volatile memory (for example, working memory (RAM)) 204a, and/or a non-volatile memory (NVM) (for example, Flash-EEPROM) 204b, or a combination thereof or including other memory types not explicitly mentioned.

Further exemplary specific embodiments relate to a computer-readable memory medium SM, including commands PRG which, upon execution by a computer 202, prompt the computer to carry out the method according to the specific embodiments.

Further exemplary specific embodiments relate to a computer program PRG, including commands which, upon execution of program PRG by a computer 202, prompt the computer to carry out the method according to the specific embodiments.

Further exemplary specific embodiments relate to a data medium signal DCS, which characterizes and/or transfers computer program PRG according to the specific embodiments. Data medium signal DCS is receivable, for example, via an optional data interface 206 of device 200. Data D are also transferable (transmittable or receivable) via optional data interface 206. In further exemplary specific embodiments, the communication or data communication with further unit 30 (FIG. 9) may also take place via optional data interface 206.

In further exemplary specific embodiments, optional data interface 206 may also be used, for example, for an update, for example, an over-the-air update.

Further exemplary aspects and specific embodiments are described below, which are each combinable individually or in combination with one another with at least one of the specific embodiments described by way of example above.

In further exemplary specific embodiments, the resources of control unit 10 (ECUs) or vehicle computer 10 (VCU) and networks connected thereto may be utilized in an efficient or optimal manner, which is implementable, for example, by a central data collection, data bundling and conveyance with the aid of the first application, for example, measuring application MA.

In further exemplary specific embodiments, methods for load balancing and/or for traffic shaping, for example, may be integrated into the first application, for example, the measuring application, as a result of which these methods for load balancing and/or for traffic shaping are applicable via the first application, for example, measuring application MA, for example, for minimizing an influence on the unit or system 10 or on the operative time behavior thereof.

In further exemplary specific embodiments, methods may be used for bundling multiple parallel logical connections, for example, via a network connection, a central access point at the transport level being enabled. In further exemplary specific embodiments, this supports an efficient resource utilization and avoids, for example, an undesirable coupling of different logical access points (for example, data sources).

In further exemplary specific embodiments, a bundling of the external communication (for example, with unit 30), for example, for all measuring functionalities and calibration functionalities MF, KF (FIG. 5), for example, and/or for runtime environment 15 (for example, AUTOSAR Adaptive), enables an application of centralized measures, for example, for access control and/or data security. In further exemplary specific embodiments, this may take place, for example, by introducing methods, for example, for authentication of a remote state and/or for encrypting, for example, an external data traffic, for example, alone, in the first application, for example, measuring application MA.

In further exemplary specific embodiments, a bundling of the external communication (for example, with unit 30) for all measuring functionalities and calibration functions MF, KF, for example, enables an application of centralized measures for ensuring the safe operation, for example, by stopping of an application by operating system 16, and/or by suspending processor time instructions (for example, temporarily no scheduling), memory limitation and memory protection, for example, by operating system 16, etc.

In further exemplary specific embodiments, a use of an identical time basis, for example, for an issuance of time stamps and/or for a request for pieces of clock information or time information, for example, by the first application, for example, measuring application MA, and/or library LIB, enables, for example, a time-synchronous measurement.

In further exemplary specific embodiments, the first application, for example, a measuring application, enables an introduction of methods for temporally, for example exactly, coordinated manipulations of data, for example, in different applications/software-parts. In further exemplary specific embodiments, a high degree of accuracy is achievable, for example, because the remaining communication latencies between the first application, for example, measuring application MA, as well as further applications ANW-1, ANW-2, etc. are minimal (for example, compared to a directly externally controlled data manipulation, for example, by unit 30).

In further exemplary specific embodiments, a measuring function MF (FIG. 5) and/or a calibration function is available, for example, only, for applications with incorporated library LIB (FIG. 9). By omitting or switching off the library functionality, it is possible in further exemplary specific embodiments to reliably, at least temporarily remove the measuring functionality and/or calibration functionality MF, KF. The addition and removal/switching off of the library functionality takes place in further exemplary specific embodiments, for example, when constructing (linking) further application ANW-1, etc., and may be checked, for example, by a party responsible for this further application ANW-1, etc.

In further exemplary specific embodiments, at least one of the following optional measures may be provided:
a) the issuance of a time stamp, for example, for a, for example, each measuring packet (for example, including a group of measured values) takes place in a measuring functionality MF of library LIB and uses, for example, a time of day of (for example, POSIX) runtime environment 15, 16. An exact correlation of the data from different further applications ANW-1, ANW-2, etc. and further data sources is hereby enabled as a result of a very high degree of accuracy of the time stamp. Alternatively or in addition, a timer, for example, PTP clock, of ECU 10 may be used in further exemplary specific embodiments.
b) The implementation in the library, for example, of a measuring and calibration library enables a simple implementation of a so-called “2-sided concept,” for example, for a calibration or parameterization functionality KF in a (further) POSIX application ANW-1. In this case, a copy of the data is requested of RAM memory 204a of operating system 16, for example, by library functions LIB. The access of further application ANW-1 to the calibration variables takes place, for example, via an adapted access function, which takes into account the active side of the 2-sided concept. The utilization and control of this mechanism, for example, by an external measuring and calibration system 30, may take place in further exemplary specific embodiments, for example, via a “Universal Measurement and Calibration Protocol” (abbreviated: XCP), for example, using an “AUTOSAR” “Single/Double Pointer Concept.”
c) The implementation of library LIB, for example, as a measuring library, and a measuring and calibration service or a data detection and data manipulation service may be expanded, for example, by a configuration method for the measuring service. In this regard, a selection of a subset of the possible measurable data may be easily implemented in further exemplary specific embodiments for sending, for example, to unit 30. In further exemplary specific embodiments, this reduces the measured data traffic, for example, to the actually required amount and allows, for example, in large setups with numerous data sources, for the flexible utilization of a limited total data throughput for measuring and calibration tasks with different focal points.

Further exemplary specific embodiments, FIG. 13, relate to a use of at least one of the aforementioned aspects, for example, of the method according to the specific embodiments and/or of device 10, 200 according to the specific embodiments and/or of computer-readable memory medium SM according to the specific embodiments and/or of computer program PRG according to the specific embodiments and/or of data medium signal DCS according to the specific embodiments for at least one of the following elements: a) measuring 302 and/or storing 304 and/or visualizing 306 data, for example, data D processable or processed in a device 10, 200 for a vehicle 20, for example, a control unit or a vehicle computer, for example, in an ongoing operation or in real time, for example, at a rate at which data D occur or accrue or are detectable, b) developing 308 units 10, 200 for a vehicle, for example, control units or vehicle computers, c) initial parameterizing 310 and/or modifying during runtime, for example, calibrating algorithms, d) supplementing 312 individual applications by a functionality for measuring and/or changing, for example, calibrating, internal data, e) creating 314 or maintaining or ensuring a compatibility of measuring accesses and/or calibration accesses for unit 10, for example, control unit or vehicle computer, for example, also in the case of distributed development of (further) applications ANW-1, etc., f) limiting 316 an access to a measuring functionality and/or calibration functionality MF, KF (FIG. 5), for example, with respect to application-internal data ID of the at least one application ANW-1 to applications within a, for example, identical runtime environment 15, 16, a protection of an integrity of the runtime environment, for example, from an installation and/or execution of unauthorized applications, a protection for the measuring and calibration functionality being ensured.

1-15 (canceled)

16. A computer-implemented method for processing data associated with an electronic unit for a vehicle, comprising:
providing a first application executable on a computing device, which is configured to execute and/or to support a communication with respect to the data, between at least one further application executable on the computing device and at least one further unit provided externally of the electronic unit.

17. The method as recited in claim 16, wherein the first application is a measuring application.

18. The method as recited in claim 16, further comprising:
bundling, using the first application, the communication between the at least one further application executable on the computing device and the at least one further unit.

19. The method as recited in claim 18, wherein the communication including multiple first data streams and the bundling includes bundling the multiple first data streams to form one second data stream.

20. The method as recited in claim 16, wherein the communication relates to functionalities with respect to at least one of the following elements: a) measuring, b) calibrating, c) monitoring, d) diagnosis, e) configuring, f) parameterizing, g) verifying, h) validating.

21. The method as recited in claim 16, wherein the first application includes a publish and/or subscribe mechanism for a service-oriented communication.

22. The method as recited in claim 21, further comprising:
using the publish and/or subscribe mechanism for providing pieces of information or data exchangeable or exchanged between, the further applications for external recording and/or visualization.

23. The method as recited in claim 16, further comprising:
providing a library which is configured to provide at least one interface for the at least one further application for an access to internal data of the at least one further application for a measuring and/or calibrating and/or monitoring and/or diagnosis and/or configuring and/or parameterizing and/or verifying and/or validating.

24. The method as recited in claim 23, further comprising:
making accessible, with the aid of the first application, using the interface, the internal data of the at least one further application for: (i) measuring functionalities, and/or (ii) calibration functionalities, and/or (iii) functionalities relating to monitoring and/or diagnosis and/or configuring and/or parameterizing, for the at least one further unit.

25. The method as recited in claim 16, further comprising:
collecting and/or writing and/or reading and/or manipulating, with the aid of the first application, data of a runtime environment, the runtime environment being an AUTOSAR Adaptive Instance and/or an operating system and/or a Unix-like operating system and/or a POSIX operating system, to enable a state monitoring of a software system.

26. The method as recited in claim 16, further comprising:
using a method for tunneling including logical network connections to forward data to the at least one further unit.

27. The method as recited in claim 23, further comprising at least one of the following elements: a) at least temporarily activating the first application, b) at least temporarily deactivating the first application, wherein the library is left incorporated or remaining incorporated in the at least one further application during the activating and/or during the deactivating.

28. A device configured to process data associated with an electronic unit for a vehicle, the device configured to:
provide a first application executable on a computing device, which is configured to execute and/or to support a communication with respect to the data, between at least one further application executable on the computing device and at least one further unit provided externally of the electronic unit.

29. A non-transitory computer-readable memory medium on which are stored commands for processing data associated with an electronic unit for a vehicle, comprising:
providing a first application executable on a computing device, which is configured to execute and/or to support a communication with respect to the data, between at least one further application executable on the computing device and at least one further unit provided externally of the electronic unit.

30. The method as recited in claim 16, wherein the method is used for at least one of the following elements: a) measuring and/or storing and/or visualizing data processable or processed in a unit for a vehicle, in an ongoing operation or in real time, at a rate at which data occur or accrue or are detectable, the unit including a control unit or a vehicle computer, b) developing units for a vehicle, the units including control units or vehicle computers, c) initial parameterizing and/or modifying during runtime, calibrating algorithms, d) supplementing individual further applications by a functionality for measuring and/or changing, including calibrating internal data, e) creating or maintaining or ensuring a compatibility of measuring accesses and/or calibration accesses for the electronic unit, f) limiting an access to a measuring functionality and/or calibration functionality with respect to application-internal data of the at least one further application to applications within an identical runtime environment, a protection of an integrity of the runtime environment from an installation and/or execution of unauthorized applications, a protection for the measuring functionality and/or the calibration functionality being ensured.
